(19) United States
(12) Patent Application Publication
(10) Pub. No.: US 2014/0358850 A1
(43) Pub. Date: Dec. 4, 2014

(54) OPEN FEEDBACK APPARATUS AND METHOD OF OPERATING THE SAME

(71) Applicant: ELECTRONICS AND TELECOMMUNICATIONS RESEARCH INSTITUTE, Daejeon-city (KR)

(72) Inventor: Jung-Eun CHA, Daejeon (KR)

(73) Assignee: ELECTRONICS AND TELECOMMUNICATIONS RESEARCH INSTITUTE, Daejeon-city (KR)

(21) Appl. No.: 14/285,792

(22) Filed: May 23, 2014

(30) Foreign Application Priority Data
May 30, 2013 (KR) 10-2013-0061442

(51) Int. Cl. G06F 17/30

(52) U.S. Cl. CPC G06F 17/30309
USPC 707/609

(57) ABSTRACT

An open feedback apparatus and a method of operating the same are disclosed. The open feedback apparatus includes a storage unit, an improved content management unit, a reliability review unit, and a version management unit. The storage unit stores content based on open source. The improved content management unit registers improved content modified based on the content by a developer with the storage unit or updates the content stored in the storage unit with the improved content. The reliability review unit generates information about the reliability of the improved content using the result value of reliability review performed based on the improved content. The version management unit assigns a version to the improved content based on the reliability information.

### CROSS REFERENCE TO RELATED APPLICATION

This application claims the benefit of Korean Patent Application No. 10-2013-0061442, filed on May 30, 2013, which is hereby incorporated by reference in its entirety into this application.

### BACKGROUND OF THE INVENTION

1. Technical Field

The present invention relates generally to an open feedback apparatus and a method of operating the same and, more particularly, to an open feedback apparatus and a method of operating the same, which are capable of providing multiple anonymous users with content based on open source and allowing the content of multiple users to be smoothly modified and shared.

2. Description of the Related Art

In order to develop software desired by customers in response to suddenly changing market trends and technical requirements, a closed-form method in which only a company releases and maintains a finished software product, as in an existing method, needs to be discarded. In reality, customers desire to select and be provided with optimum hardware and software in a variety of market and functional alternative environments.

Accordingly, an open feedback system that can be evolved in various manners in accordance with users having various viewpoints based on common open source is essential to all companies, software-related communities, and personal software developers.

If the development and supply of software and systems are unilaterally performed by large-sized companies, as in the past, it will be difficult for both developers and users to make mutual and continuous profits. For this reason, in order to increase companies or developers' profits by maximizing their developing abilities, they are increasingly dependent on a scheme of providing an open space in which a plurality of anonymous developers can take part and acquiring active and positive participatory opinions from the open space.

An open feedback system is a system for disclosing developed content and a developed system and enabling a plurality of developers who want to use the disclosed content and system to freely share information about the disclosed content and system. That is, the open feedback system collects products processed using various technical deployment methods based on the viewpoints of a plurality of developers, reviews the collected products, and discloses the products again. Accordingly, it is very important to establish a process of rapidly and accurately performing a series of processes of releasing, obtaining, and reviewing software improved by users. For this purpose, an open feedback system also needs to be systematically constructed based on the established process. In particular, in order to sustain the diversity of products and the potential trend of development, an operator should be prevented from arbitrarily manipulating or deleting software and content related to the software. Furthermore, since an official version needs to be assigned in agreement with the opinions a majority, the feedback of users should be defined and operated in a reviewed system via an official process.

In connection with this, Korean Patent Application Publication No. 2001-0090661 discloses a method of evaluating and using software in an interactive form.

### SUMMARY OF THE INVENTION

Accordingly, the present invention has been made keeping in mind the above problems occurring in the conventional art, and an object of the present invention is to provide an open feedback apparatus that is capable of securing reliability and autonomy for content and a system.

In accordance with an aspect of the present invention, there is provided an open feedback apparatus, including a storage unit configured to store content based on open source; an improved content management unit configured to register improved content modified based on the content by a developer with the storage unit or to update the content stored in the storage unit with the improved content; a reliability review unit configured to generate information about reliability of the improved content using a result value of reliability review performed based on the improved content; and a version management unit configured to assign a version to the improved content based on the reliability information.

The reliability review unit may perform the reliability review in accordance with a predetermined test flow.

The reliability review unit may request the tester review of the improved content from a plurality of testers, may request the administrator review of the improved content from an administrator of the open feedback apparatus, and may request the peer review of the improved content

The improved content management unit may check whether or not the previous version of the improved content has been stored in the storage unit; and the reliability review unit may include information about the previous version of the improved content in the reliability information if the previous version of the improved content has been stored in the storage unit.

The version management unit may register the improved content having a new version if the result value included in the reliability information is equal to or higher than a predetermined threshold and the information about the previous version of the improved content is not included in the reliability information.

The version management unit may update the version of the improved content if the result value included in the reliability information is equal to or higher than the predetermined threshold and the information about the previous version of the improved content is included in the reliability information.

The version management unit may provide the developer with information about a feedback of the improved content if the result value included in the reliability information is less than the predetermined threshold.

The open feedback apparatus may further include a user support unit configured to provide the developer with the content stored in the storage unit on a category basis.

The open feedback apparatus may further include an access statistics unit configured to compile the statistics of users who have accessed the content stored in the storage unit via the user support unit and content which have been accessed by the users.

The user support unit may provide the developer with information about the content and the improved content in a community bulletin board form.

In accordance with an aspect of the present invention, there is provided a method of operating an open feedback apparatus, including storing, by a storage unit, content based on open source; registering, by an improved content management unit, improved content modified based on the content by a developer with the storage unit, or updating, by an improved content management unit, the content stored in the storage unit with the improved content; generating, by a reliability review unit, information about reliability of the improved content using a result value of reliability review performed based on the improved content; and assigning, by a version management unit, a version to the improved content based on the reliability information.

Generating the information about the reliability of the improved content may include performing the reliability review in accordance with a predetermined test flow.

Generating the information about the reliability of the improved content may include requesting the tester review of the improved content from a plurality of testers, requesting the administrator review of the improved content from an administrator of the open feedback method, and requesting the peer review of the improved content.

Assigning the version to the improved content may include registering the improved content having a new version if the result value included in the reliability information is equal to or higher than a predetermined threshold and the information about the previous version of the improved content is not included in the reliability information.

Assigning the version to the improved content may include updating a version of the improved content if the result value included in the reliability information is equal to or higher than the predetermined threshold and the information about the previous version of the improved content is included in the reliability information.

Assigning the version to the improved content may include providing the developer with information about a feedback of the improved content if the result value included in the reliability information is less than the predetermined threshold.

The open feedback method may further include, after storing the content, providing, by a user support unit, the developer with the content stored in the storage unit on a category basis.

The open feedback method may further include, after providing the developer with the content stored in the storage unit on a category basis, compiling, by an access statistics unit, statistics of users who have accessed the content stored in the storage unit via the user support unit and content which have been accessed by the users.

Providing the developer with the content stored in the storage unit on a category basis may include providing the developer with information about the content and the improved content in a community bulletin board form.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an open feedback apparatus according to an embodiment of the present invention;

FIGS. 2 and 3 are flowcharts illustrating a method of operating the open feedback apparatus according to an embodiment of the present invention; and

FIGS. 4 and 5 are flowcharts illustrating a process of performing reliability review in the method of operating the open feedback apparatus according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

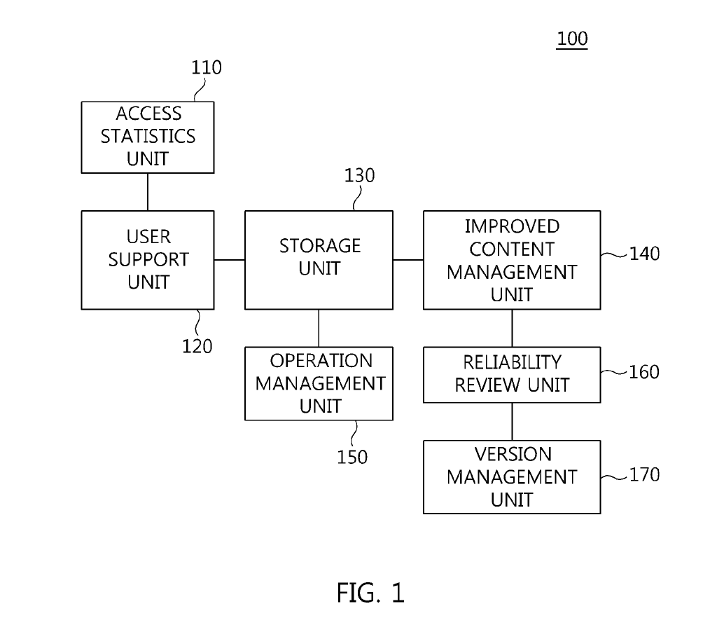

An open feedback apparatus 100 according to an embodiment of the present invention is described below. FIG. 1 is a block diagram of an open feedback apparatus according to an embodiment of the present invention.

As illustrated in FIG. 1, the open feedback apparatus 100 according to this embodiment of the present invention may include an access statistics unit 110, a user support unit 120, a storage unit 130, an improved content management unit 140, an operation management unit 150, a reliability review unit 160, and a version management unit 170. The components of the open feedback apparatus 100 are described below.

The user support unit 120 functions to provide a plurality of users with content stored in the storage unit 140 on a category basis. In this case, the content is, for example, content generated by a content provider based on open source. The user support unit 120 may further provide a plurality of users with improved content stored in the storage unit 140. The improved content is content modified by a developer or a user based on the original content. The content or improved content may have unique version information.

More particularly, the user support unit 120 may post, for example, information that is considered to be useful for a user. For example, the information may be provided in a one-way manner, that is, in the form of notification information that does not require feedback from a user.

The user support unit 120 may provide such information in the form of an open project. That is, the user support unit 120 may support products shared by users so that the products are deployed in various forms. For example, the user support unit 120 may provide such information in the form of a forum and queries/answers for each subject in which a plurality of persons can have a discussion on a common technical subject

The user support unit 120 may provide a plurality of users with the above-described information, for example, information about content and improved content, in the form of a community bulletin board. It is however to be noted that such a form is only an example and may be provided in various manners.

The access statistics unit 110 functions to compile statistics of users who have accessed content stored in the storage units 140 and statistics of content which has been accessed by the users via the user support unit 120. Accordingly, the open feedback apparatus 100 may obtain information having higher reliability using such statistics information, and may easily obtain results from the viewpoint of subsequent management.

The storage unit 130 functions to store content generated by a content provider based on open source as described above. Furthermore, the storage unit 130 functions to store improved content modified by a user based on content.

The operation management unit 150 functions to generally manage, for example, users, content, security, and servers. Furthermore, the operation management unit 150 may provide a common manipulation function for the storage unit 140 of the open feedback apparatus.

The improved content management unit 140 functions to register improved content, modified from content based on open source stored in the storage unit 130 by a developer, with the storage unit 130, or update the content stored in the storage unit 130 with the improved content. That is, when a developer registers improved content with the storage unit 130, the improved content management unit 140 checks whether or not the previous version of the improved content has been stored in the storage unit 130. If the previous version of the improved content has been stored in the storage unit 130, the improved content management unit 140 updates the improved content with new improved content If the previous version of the improved content has not been stored in the storage unit 130, that is, if the improved content to be registered by the developer is a new version, the improved content management unit 140 directly stores and registers the improved content in and with the storage unit 140.

The improved content management unit 140 may further function to identify and name products whose versions need to continue to be managed in connection with content that is managed by the open feedback apparatus 100 of the present invention. Furthermore, the improved content management unit 140 may function to record a history of content modified by a developer and to notify the developer of the history.

The reliability review unit 160 functions to generate information about the reliability of improved content based on the result value of the reliability review that has been performed on the improved content registered or updated by the improved content management unit 140. The reliability review may be basically classified into three processes and be then performed.

A first process for the reliability review is to request the tester review of the improved content from a plurality of testers. In this case, the testers may refer to common users. That is, in the first process, the opinions of common users who use the open feedback apparatus 100 of the present invention are collected, and whether or not an administrator review is required for a convergence result release is determined. If a plurality of testers determines that the reliability of the improved content is low, that is, if the improved content has no special advantage compared to a previous version or if there is a reason, such as the fact that an improvement is insignificant, the following review processes may not be additionally performed.

A second process for the reliability review is to request the administrator review of the improved content from the administrator of the open feedback apparatus. In this case, if a plurality of administrators is present, that is, if collective administrators are present, the opinions of the collective administrators are collected and whether or not peer review is required is determined. As in the tester review, if the collective administrators determine that the reliability of the improved content is low, the following review processes may not be additionally performed.

A third process for the reliability review is to request the peer review of the improved content. In this case, the peers may refer to the peers of a content provider who provided an open source first or the peers of a developer who have tried to distribute the improved content

The reliability review unit 160 may perform the three review processes, that is, the tester review, the administrator review, and the peer review in accordance with a predetermined test flow. For example, the reliability review unit 160 may sequentially perform the tester review, the administrator review, and the peer review. Accordingly, a result value may be obtained through the three review processes.

Furthermore, if the previous version of improved content is present in the storage unit 130, the reliability review unit 160 may further include information about the previous version of the improved content in reliability information.

The version management unit 170 functions to assign the version of the improved content based on the reliability information generated by the reliability review unit 160. That is, the version management unit 170 assigns a new version to only the improved content whose reliability review has been passed in the reliability review unit 160. Furthermore, the version management unit 170 may manage a history of versions. Accordingly, content improved by other developers can be improved.

Conditions under which the version management unit 170 assigns a new version to improved content are as follows. The version management unit 170 compares, for example, a result value included in reliability information with a predetermined threshold. If, as a result of the comparison, it is determined that the result value included in the reliability information is equal to or higher than the predetermined threshold and information about the previous version of improved content is not included in the reliability information, the version management unit 170 registers a new version for the improved content. Furthermore, if, as a result of the comparison, it is determined that the result value included in the reliability information is equal to or higher than the predetermined threshold and information about the previous version of the improved content is included in the reliability information, the version management unit 170 updates the version of the improved content. Furthermore, if, as a result of the comparison, it is determined that the result value included in the reliability information is less than the predetermined threshold, the version management unit 170 provides a developer with information about the feedback of the improved content. The developer may become aware of his or her problem or weak point for the improved content based on the feedback information. Accordingly, improved content having high reliability may be developed.

Furthermore, the version management unit 170 may compile statistics of the percentage of the improved content that has passed the reliability review and the percentage of the improved content that has not passed the reliability review, and may store the percentages as statistical values.

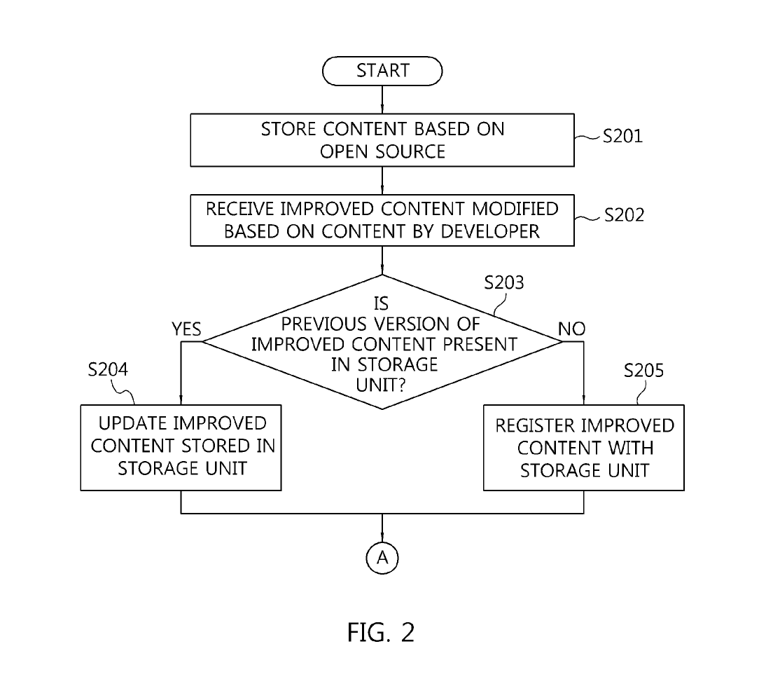

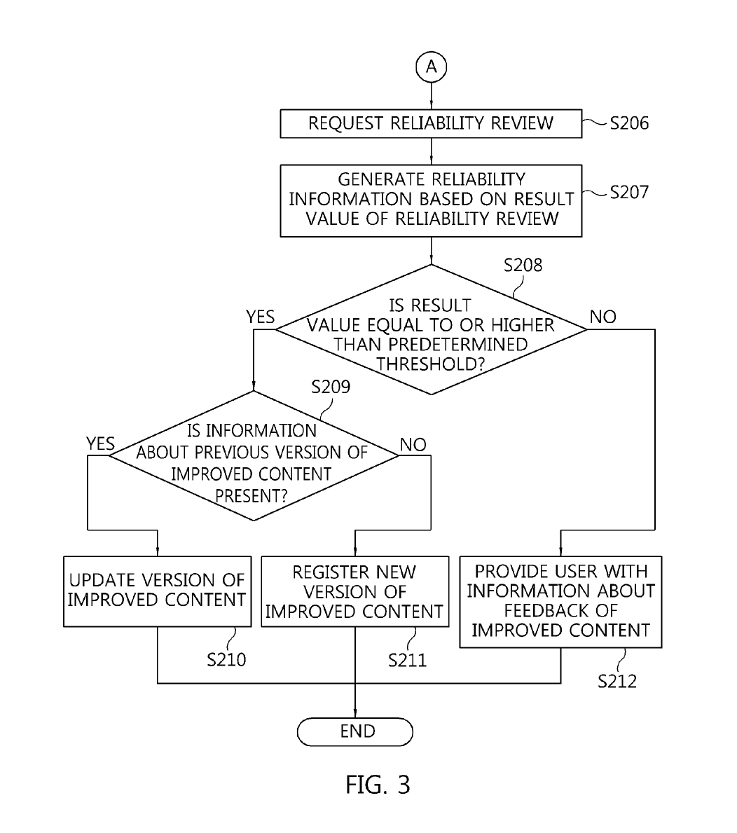

A method of operating the open feedback apparatus according to an embodiment of the present invention is described below with reference to FIGS. 2 and 3. FIGS. 2 and 3 are flowcharts illustrating the method of operating the open feedback apparatus according to this embodiment of the present invention. In the following description, redundant descriptions that have been given in conjunction with FIG. 1 are omitted for clarity of description.

First, content based on open source is stored at step S201. The content refers to content registered with the open feedback apparatus of the present invention by a content provider.

The user support unit 120 provides users with the content stored in the storage unit 130 on a category basis. Since the detailed operation performed by the user support unit has been described in detail with reference to FIG. 1, a description thereof is omitted for clarity of description.

Thereafter, improved content uploaded by the developer and modified based on the provided content is received at step S202. Step S202 may be performed by the improved content management unit 140.

The improved content management unit 140 determines whether or not the previous version of the improved content has been stored in the storage unit 130 at step S203. If, as a result of the determination at step S203, it is determined that the previous version of the improved content has been stored in the storage unit 130, the process proceeds to step S204. If, as a result of the determination at step S203, it is determined that the previous version of the improved content has not been stored in the storage unit 130, the process proceeds to step S205.

At step S204, the previous version of the improved content stored in the storage unit 130 is updated with the version of the improved content received at step S202. Once the update has been completed, the process proceeds to step S206.

At step S205, the improved content received at step S202 is registered with the storage unit 130.

At step S206, the reliability review unit 160 requests the reliability review of the improved content that has been updated or registered at step S204 or S205. The reliability review may be performed in accordance with a predetermined test flow as described above. Since the method of performing the reliability review has been described in detail with reference to FIG. 1, a description thereof is omitted. Once the reliability review of the improved content has been completed in response to the request at step S206, the process proceeds to step S207.

At step S207, reliability information is generated using a result value obtained using the reliability review. The reliability information may include information about the previous version of the improved content if it is determined that the previous version of the improved content has been stored in the storage unit 130 at step S203, as well as the result value.

Thereafter, whether or not the result value is equal to or higher than a predetermined threshold is determined at step S208. If, as a result of the determination at step S208, it is determined that the result value is equal to or higher than the predetermined threshold, this indicates that the improved content has passed the reliability review. If, as a result of the determination at step S208, however, it is determined that the result value is less than the predetermined threshold, this indicates that the improved content has not passed the reliability review. If, as a result of the determination at step S208, it is determined that the result value is equal to or higher than the predetermined threshold, the process proceeds to step S209. If, as a result of the determination at step S208, it is determined that the result value is less than the predetermined threshold, the process proceeds to step S212.

At step S209, whether or not information about the previous version of the improved content has been stored in the reliability information is determined. If, as a result of the determination at step S209, it is determined that the information about the previous version of the improved content has been stored in the reliability information, the process proceeds to step S210. If, as a result of the determination at step S209, it is determined that the information about the previous version of the improved content has not been stored in the reliability information, the process proceeds to step S211.

At step S210, the version of the improved content is updated. Once the version of the improved content has been updated, the process is terminated.

At step S211, a new version is assigned to the improved content and the improved content is registered. Once the improved content has been registered, the process is terminated.

Meanwhile, if, as a result of the determination at step S208, it is determined that the result value is less than the predetermined threshold, information about the feedback of the improved content is provided to the content provider at step S212. Thereafter, the process is terminated

Although not shown, the version management unit 170 may further compile statistics of the percentage of the improved content that has passed the reliability review and the percentage of the improved content that has not passed the reliability review, after steps S210, S211, and S212. The collected statistics may be used for subsequent management.

Furthermore, although not illustrated, the access statistics unit 110 may compile statistics of users who have accessed the content stored in the storage unit 130 via the user support unit 120 and content which have been accessed by the users, after step S201.

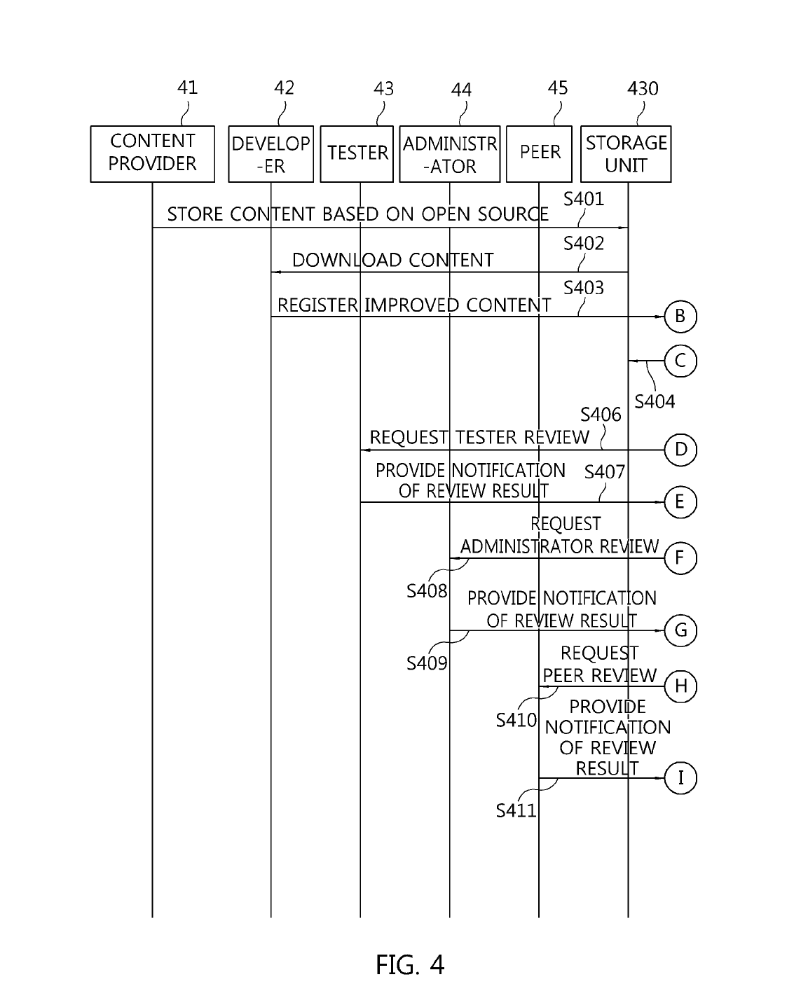

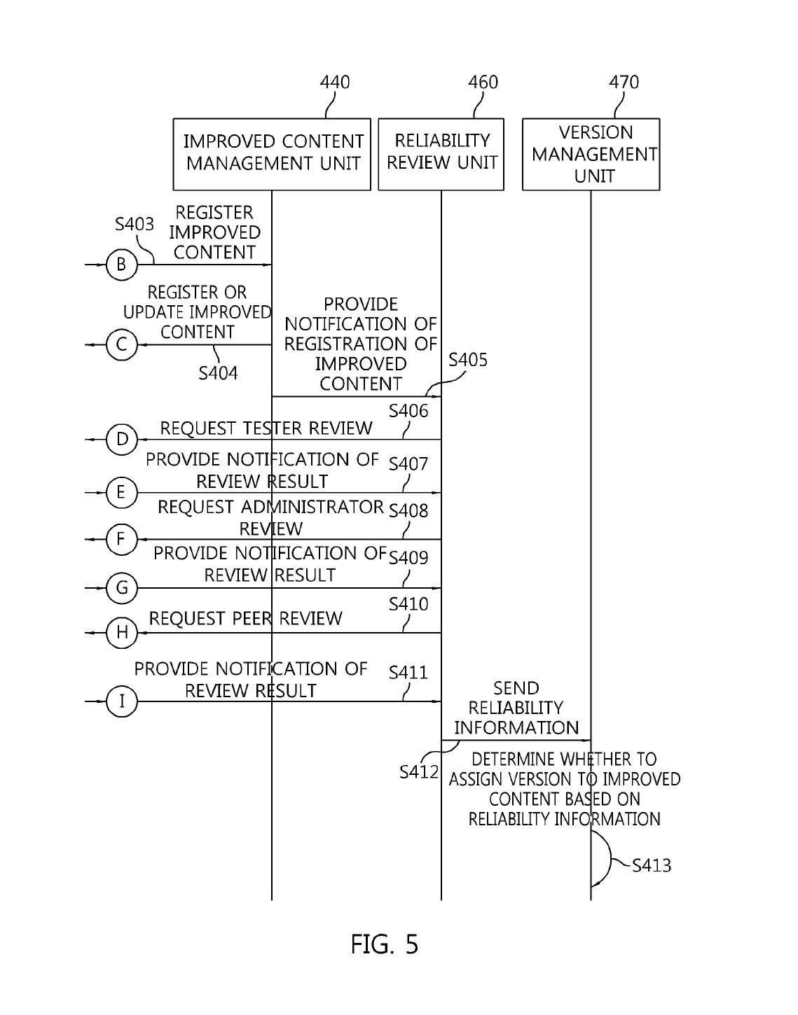

The process of performing reliability review illustrated in FIGS. 2 and 3 is further described below with reference to FIGS. 4 and 5. FIGS. 4 and 5 are flowcharts illustrating a process of performing reliability review in the method of operating the open feedback apparatus according to the present invention. It is to be noted that the following description is only for helping understanding of the process and the process is not limited to the following processes.

First, a content provider 41 stores content based on open source in the storage unit 430 at step S401. The stored content is accessed by a developer 42 and users via the user support unit, as described in conjunction with FIG. 1.

The developer 42 downloads the content stored in the storage unit 430 at step S402. The developer 42 may access the content via the user support unit as described above and download the content

Thereafter, the developer 42 registers improved content modified based on the content with an improved content management unit 440 at step S403.

The improved content management unit 440 registers the improved content received from the developer 42 with the storage unit 430, or updates the content stored in the storage unit 430 with the improved content at step S404. As described above, at step S404, the improved content stored in the storage unit 430 is updated if the previous version of the improved content is present, and the improved content is registered with the storage unit 430 if the previous version of the improved content is not present.

The improved content management unit 440 notifies the reliability review unit 460 of the registration of the improved content at step S405. The reliability review unit 460 may become aware of whether or not new improved content has been registered at step S405.

Thereafter, the reliability review unit 460 requests the tester review of the improved content from a plurality of testers 43 at step S406. The testers may refer to common users. The plurality of testers determines the reliability of the improved content and sends the result of the review to the reliability review unit 460 at step S407.

If, as a result of the determination at step S407, it is determined that the reliability of the improved content is low, the following steps related to reliability determination may not be performed and the version management unit may send feedback information to the developer 42.

Step S408 is performed when the improved content has passed the tester review. At step S408, the reliability review unit 460 requests administrator review from an administrator 44.

Thereafter, as at step 407, the administrator 44 notifies the reliability review unit 460 of the result of the administrator review at step S409. If the reliability of the improved content is low at step S409, the following reliability determination step may not be performed, and the version management unit may send feedback information to the developer 42.

Step S410 is performed if the improved content has passed the administrator review. At step S410, the reliability review unit 460 requests peer review from peers 45. As described above, the peers may refer to the peers of a content provider who provided an open source first or the peers of the developer 42 who have tried to distribute the improved content

The peers notify the reliability review unit 460 of the result of the peer review at step S411.

Thereafter, the reliability review unit 460 sends reliability information to the version management unit at step S412.

The version management unit 470 determines whether or not to assign a new version to the improved content based on the received reliability information at step S413. Since whether or not to assign a new version to the improved content has been described in detail in conjunction with FIG. 1, a detailed description thereof is omitted for clarity of description.

As described above, the open feedback apparatus and the method of operating the same according to the present invention are advantageous in that the reliability of the development of software and content can be ensured and also the level of maintenance and repair can be improved using the collective technological intelligence of multiple users.

Furthermore, the open feedback apparatus and the method of operating the same according to the present invention are advantageous in that content can be updated with higher quality because a plurality of reliability review procedures is performed upon updating the versions of content distributed by a content provider or a user.

The teachings of principles of the present invention may be implemented by a combination of hardware and software. Furthermore, the software may be implemented as an application that is actually implemented in a program storage unit. The application may be uploaded to a machine including a specific architecture and executed by the machine. The machine preferably may be implemented in a computer platform having hardware, such as one or more Central Processing Units (CPUs), one or more computer processors, one or more pieces of RAM, and one or more Input/Output (I/0) interfaces. The computer platform may further include an operating system and micro instruction code. A variety of the processes and functions described above may be some of the micro instruction code, part of an application or a specific combination of them, which may be executed by various processing units including CPUs. In addition, a variety of other peripheral devices, such as an additional data storage unit and a printer, may be connected to the computer platform.

It is to be understood that the actual connections between system components or process function blocks may be changed depending on a method of programming the principles of the present invention because some of the system components of the configurations and the methods illustrated in the accompanying drawings are implemented in software. If the teachings are given, those skilled in the art may take the implementations of the principles of the present invention and similar implementations or configurations into consideration.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An open feedback apparatus, comprising:
a storage unit configured to store content based on open source;
an improved content management unit configured to register improved content modified based on the content by a developer with the storage unit or to update the content stored in the storage unit with the improved content;
a reliability review unit configured to generate information about reliability of the improved content using a result value of reliability review performed based on the improved content; and
a version management unit configured to assign a version to the improved content based on the reliability information.

2. The open feedback apparatus of claim 1, wherein the reliability review unit performs the reliability review in accordance with a predetermined test flow.

3. The open feedback apparatus of claim 2, wherein the reliability review unit requests tester review of the improved content from a plurality of testers, requests administrator review of the improved content from an administrator of the open feedback apparatus, and requests peer review of the improved content

4. The open feedback apparatus of claim 1, wherein:
the improved content management unit checks whether or not a previous version of the improved content has been stored in the storage unit; and
the reliability review unit includes information about the previous version of the improved content in the reliability information if the previous version of the improved content has been stored in the storage unit.

5. The open feedback apparatus of claim 4, wherein the version management unit registers the improved content having a new version if the result value included in the reliability information is equal to or higher than a predetermined threshold and the information about the previous version of the improved content is not included in the reliability information.

6. The open feedback apparatus of claim 5, wherein the version management unit updates a version of the improved content if the result value included in the reliability information is equal to or higher than the predetermined threshold and the information about the previous version of the improved content is included in the reliability information.

7. The open feedback apparatus of claim 1, wherein the version management unit provides the developer with information about a feedback of the improved content if the result value included in the reliability information is less than the predetermined threshold.

8. The open feedback apparatus of claim 1, further comprising a user support unit configured to provide the developer with the content stored in the storage unit on a category basis.

9. The open feedback apparatus of claim 8, further comprising an access statistics unit configured to compile statistics of users who have accessed the content stored in the storage unit via the user support unit and content which have been accessed by the users.

10. The open feedback apparatus of claim 8, wherein the user support unit provides the developer with information about the content and the improved content in a community bulletin board form.

11. A method of operating an open feedback apparatus, comprising:
storing, by a storage unit, content based on open source;
registering, by an improved content management unit, improved content modified based on the content by a developer with the storage unit, or updating, by an improved content management unit, the content stored in the storage unit with the improved content;
generating, by a reliability review unit, information about reliability of the improved content using a result value of reliability review performed based on the improved content; and
assigning, by a version management unit, a version to the improved content based on the reliability information.

12. The method of claim 11, wherein generating the information about the reliability of the improved content comprises performing the reliability review in accordance with a predetermined test flow.

13. The method of claim 12, wherein generating the information about the reliability of the improved content comprises requesting tester review of the improved content from a plurality of testers, requesting administrator review of the improved content from an administrator of the open feedback method, and requesting peer review of the improved content.

14. The method of claim 11, wherein assigning the version to the improved content comprises registering the improved content having a new version if the result value included in the reliability information is equal to or higher than a predetermined threshold and the information about the previous version of the improved content is not included in the reliability information.

15. The method of claim 14, wherein assigning the version to the improved content comprises updating a version of the improved content if the result value included in the reliability information is equal to or higher than the predetermined threshold and the information about the previous version of the improved content is included in the reliability information.

16. The method of claim 11, wherein assigning the version to the improved content comprises providing the developer with information about a feedback of the improved content if the result value included in the reliability information is less than the predetermined threshold.

17. The method of claim 11, further comprising, after storing the content, providing, by a user support unit, the developer with the content stored in the storage unit on a category basis.

18. The method of claim 17, further comprising, after providing the developer with the content stored in the storage unit on a category basis, compiling, by an access statistics unit, statistics of users who have accessed the content stored in the storage unit via the user support unit and content which have been accessed by the users.

19. The method of claim 17, wherein providing the developer with the content stored in the storage unit on a category basis comprises providing the developer with information about the content and the improved content in a community bulletin board form.
